(19) United States
(12) Patent Application Publication
(10) Pub. No.: US 2024/0280516 A1
(43) Pub. Date: Aug. 22, 2024

(54) METHOD FOR DETERMINING MICROSTRUCTURAL DETERIORATION AND REMAINING LIFE OF A HARDENED METAL COMPONENT

(71) Applicant: AKTIEBOLAGET SKF, GOTEBORG (SE)

(72) Inventors: Predrag ANDRIC, Zeist (NL); Reinder Hindrik VEGTER, Culemborg (NL)

(21) Appl. No.: 18/438,852

(22) Filed: Feb. 12, 2024

(30) Foreign Application Priority Data
Feb. 20, 2023 (DE) 102023201445.9

(51) Int. Cl. G01N 23/2055

(52) U.S. Cl. CPC G01N 23/2055

(57) ABSTRACT

A method of indicating an evolution of microstructural deterioration of a hardened metal object, in relation to fatigue load cycles, N, exerted on the hardened metal object includes determining the evolution of microstructural deterioration by means of a relationship between a rate of change in a measurable parameter indicative of microstructural condition of the hardened metal object, and a fatigue damage rate of the hardened metal object, wherein the method is given by the equation:

b(t)=bₜₕ+(b_{sd}−bₜₕ)exp[γₛ(t/t₀)^{d}]

where b(t) is a time dependent measurable parameter indicative of microstructural condition.

### CROSS-REFERENCE

This application claims priority to German patent application no. 10 2023 201 445.9 filed on Feb. 20, 2023, the contents of which are fully incorporated herein by reference.

### TECHNICAL FIELD

The present disclosure relates to a method for determining microstructural deterioration of a hardened metal object. The present disclosure also relates to a method of determining the remaining life of a hardened metal object. In addition, the present disclosure also relates to a computer program and a computer readable medium.

### BACKGROUND

Fatigue, one of the most common material degradation mechanisms in industry in general and in the bearing industry in particular, occurs when material experiences lengthy periods under repeated or cyclic stresses which can lead to failure at stress levels much lower than the tensile or yield strength. To optimise the design and safety of machinery, it is therefore important to have an accurate prediction of the life and/or the remaining life of mechanical components.

Bearings, such as roller bearings and ball bearings, are mechanical elements which are used in many different industrial applications. By way of example, a bearing may comprise several different mechanical components which are subjected to loads during use. The bearing components which are subjected to load are typically an inner ring, an outer ring and a plurality of rolling elements, i.e. rollers and/or balls. Decay of hardened bearing steels under cyclic contact loading, commonly referred as Rolling Contact Fatigue (RCF), represents a high-cycle fatigue process in which material damage is driven by the accumulation of micro-plasticity. The damage accumulation under RCF eventually exceeds a certain critical limit, which as a consequence leads to the bearing failure, which in turn may have potential catastrophic results for the machinery into which it is installed.

In current commonly used bearing life models, the failure of bearings is calculated using a mathematical framework that has been developed over the past decades. A first model predicted the L10 life of a bearing, which is the operating time or number of load cycles after which 10% of a tested population of bearings has failed. The calculation is based on dynamic load, equivalent bearing load and a factor dependent on the geometry of the rolling contact. The calculated life of a bearing is a number that is given on the basis of a statistical test, yet the life is not an absolute repeatable quantity, but depends on context of the application in which it is installed. Since the testing method provides a statistics-based life number, any calculation based thereon will always be inherently statistical as well. As such, it is not an accurate assessment of the actual state of a particular bearing.

In order to extend the life of a bearing it is known to remanufacture the complete bearing, or at least to remanufacture certain components of the bearing. For example, a raceway surface of an inner or outer ring may be re-machined to thereby obtain a re-machined raceway surface. Thereby, a worn raceway surface may be removed. As a consequence, the life of the bearing can be extended.

However, not all bearings are suitable to be remanufactured. For example, a bearing component may be damaged to an extent so that remanufacturing would not significantly extend the life.

As explained above, statistical bearing life prediction models such as L10 are not suitable for this purpose as it does not measure the actual state of a particular bearing. Instead, bearing life models using the actual state of a hardened metal component as input can be used. The actual state can be determined based on an observable parameter. The observable parameter can be compared to the same observable parameter as the component is new and when it is prone to fail. As such, a more accurate calculation of the actual remaining life of the particular component can then be made. This can better support decision making on how the metal component should be handled, such as to continue to use it, replace it with a new component, or if it is a suitable candidate to remanufacture. The better the prediction of remaining life is, the more effective use of the components and resources can be achieved.

Therefore, in view of the above, there is a need to develop improved methods for estimating the microstructural state and its remaining life of hardened metal components such as bearings.

### SUMMARY

In view of the above, an aspect of the disclosure is to provide an improved method for indicating an evolution of microstructural deterioration of a hardened metal object in relation to fatigue load cycles exerted on the hardened metal object, or at least to provide a suitable alternative.

A further aspect of the disclosure is to provide an improved method of indicating an evolution of a Fatigue Damage Index for a hardened metal object as a function of fatigue load cycles, or at least to provide a suitable alternative.

A still further aspect of the disclosure is to provide an improved method of determining the expected life a hardened metal object as a function of fatigue load cycles, or at least to provide a suitable alternative.

A yet further aspect of the disclosure is to provide an improved method of determining the remaining life of a hardened metal object in relation to fatigue load cycles exerted on the hardened metal object, or at least to provide a suitable alternative.

A yet further aspect of the disclosure is to provide a computer program product to perform at least one method according to the previous objects of the disclosure.

A yet further aspect of the disclosure is to provide a computer readable medium containing program instructions to perform at least one method according to the previous objects.

Embodiments of the present disclosure have their basis in a metal physics description of how hardened metal materials behave under high cycle fatigue conditions, including not only the effects of the Hertzian contact stress field but also the effects of the operating temperature, superimposed (hoop and residual) stresses and speed. The term fatigue includes at least one of rolling contact fatigue (RCF) and structural fatigue, such as rotating bending fatigue, torsion fatigue, uniaxial fatigue, including push-pull fatigue, and multiaxial fatigue. Fatigue damage is seen as a cumulative small-scale plastic deformation process, being controlled by a thermally activated dislocation climb process. The damage induced is a result of a secondary creep-like dislocation process, where iron self-diffusion-controlled climb constitutes the rate controlling step, while the major part of the damage induced is a result of dislocation glide, once the dislocations are freed from the obstacles via the climb process (climb and glide). The damage process is therefore driven by the applied shear stress field and is rate controlled via diffusion-controlled climb. These terms and this process is well known by the person skilled in the art.

Thus, there is provided a method for indicating an evolution of microstructural deterioration of a hardened metal object in relation to fatigue load cycles, N, exerted on the hardened metal object. The method comprises a step of determining the evolution of microstructural deterioration by means of a relationship between a rate of change in a measurable parameter indicative of microstructural condition of the hardened metal object and a fatigue damage rate of the hardened metal object. The method is given by the equation

$$b ( t ) = {b}_{th} + ( {b}_{sd} - {b}_{th} ) exp [ - {{γ}_{s} ( \frac{t}{{t}_{0}} )}^{d} ]$$

where:
b(t) is a time dependent measurable parameter indicative of microstructural condition when time

$$t = \frac{N}{f} ,$$

where N is fatigue exposure in number of load cycles and f is the frequency of the fatigue load cycles (Hz),
bₜₕ is a minimum measurable parameter indicative of microstructural condition when

$$t = \frac{N}{f} \to ∞ ,$$

b_{sd} is a measurable parameter indicative of microstructural condition after shake down phase,
γₛ is plastic strain accumulation,
t₀ is a time normalization constant (seconds), and
d is a temperature dependent material exponential coefficient, where d<1.

By the provision of a method according to the first aspect as disclosed herein, an improved method for indicating an evolution of microstructural deterioration of a hardened metal object is achieved. The method consists of a measurement of a measurable parameter indicative of microstructural condition which is based on assessment of the metal physics state of the hardened metal object. This measurement result is related to pre-determined value of an unused state and an end-of-life state of the steel that the object is made of. The relation between the measurement and the end-of-life state of the steel is established by taking into account the operation conditions of the steel object put together with the actual residual stress state during the fatigue life-time of the object.

More specifically, it has been realized by the inventors when investigating deviations in the predictions of previous life models with actual life tests and understanding why that is, that plastic strain rate due to creep-like process is time dependent and slows down during rolling contact fatigue (RCF). Previously used methods and models assumed that the plastic strain rate due to creep is time independent, i.e. constant in time. Therefore, the temperature dependent material exponential coefficient d has been introduced to reflect the effect of time dependent creep strain rate, where d<1. The new method is based on the physical assumption that the change of the observable parameter is proportional to the micro-level plastic strain accumulated during RCF. This gives a more accurate result compared to assuming a plastic strain rate due to creep is constant in time.

The new method also reflects that micro-plasticity after the shake-down phase is controlled by a low temperature creep-like process. Low temperature creep usually occurs at higher applied stresses in hardened steels.

The predictions of the new inventive method indicating the evolution of microstructural deterioration are better than previous methods in a wider range of operating conditions. The predictions are in fact in excellent agreement with experiments obtained in bearing fatigue tests across wide range of combined operating conditions, such as temperature, number of stress cycles, loads or contact pressure, to name a few. Further, the method is very easy to use and depends only on the subsurface stress state and running temperature.

d depends on the material of the hardened metal objects and may be decided for any given material by testing.

Optionally,

$$d = - 0.012 \frac{1}{1 ° C} \cdot {T}_{C} + 4.636 ,$$

where T_{C} is operating temperature in Celsius (° C.).

Optionally, the plastic strain accumulation γₛ is given by the equation:

$${γ}_{s} = C {〈 \frac{{τ}_{xz}}{{τ}_{0}} 〉}^{C} exp ( - \frac{{Q}_{eff} - Δ V {σ}_{H}}{{k}_{b} T} )$$

where:
τ_{xz} is an orthogonal shear stress (Pa),
τ₀ is an activation stress for creep (Pa),
C is a proportionally constant for the shear stress amplitude,
c is an exponent for the shear stress amplitude,
Q_{eff} is an activation energy for creep (J),
k_{b} is a Boltzmann constant (J/K),
T is an operating temperature (K),
σ_{H} is the Hertzian hydrostatic pressure (Pa), and
ΔV (m³) is a material activation volume,
where at least one of the material related parameters bₜₕ, τ₀, d, and/or ΔV are functions of temperature. This further improves the accuracy of the indicating the evolution of microstructural deviations.

Optionally, at least one of the material related functions of temperature bₜₕ, τ₀, d, and/or ΔV are described as:

$${b}_{th} = 3.33 \cdot {10}^{- 4} \frac{1}{{( 1 ° C )}^{2}} {T}_{C}^{2} - 7.4 \cdot {10}^{- 3} \frac{1}{1 ° C} {T}_{C} + 7.486$$

$${τ}_{o} = - 0.2 \frac{1}{1 ° C} \cdot {T}_{C} + 360.6 ( MPa )$$

$$d = - 0.012 \frac{1}{1 ° C} \cdot {T}_{C} + 4.636$$

$$Δ V = ( 3.33 \cdot {10}^{- 4} \frac{1}{{( 1 ° C )}^{2}} {T}_{c}^{2} - 3.2 \cdot {10}^{- 4} \frac{1}{1 ° C} {T}_{c} + 1.957 ) \cdot {10}^{- 5} ( \frac{{m}^{3}}{mol} )$$

where T_{C} is operating temperature in Celsius (° C.).

A minor modification is then applied to the proportionality constant C and exponent c, leading to C=5e16 and c=11. Note that all four material functions are expressed only as a function of temperature T_{C} expressed in ° C.

Thus, further optionally, at least one of the constants b_{sd}, C, c and/or Q_{eff}(J/mol) are defined as:

$${b}_{sd} = 5.95$$

$$C = 5 \cdot {10}^{16}$$

$$c = 11$$

$${Q}_{eff} ( \frac{J}{mol} ) = 140 \cdot {10}^{3}$$

Different material would require minor adjustment to the function used, but the method still applies. The constants and functions of temperature above can be determined by performing tests for a plurality of test components under known and different (i) load conditions, (ii) temperatures and (iii) running number of cycles and by measuring actual b(t) using a non-destructive technique for the plurality of test components run at different and known loads, temperatures and number of cycles. When the constants are defined as a function of the temperature and load, b(t) can be calculated using the model.

Optionally, the measurable parameter indicative of the microstructural condition of the hardened metal object is a Full Width at Half Maximum, FWHM, obtainable from a diffraction peak of an X-ray diffraction measurement.
b(t) is a time dependent FWHM peak width (degrees) when time

$$t = \frac{N}{f} ,$$

where N 1S fatigue exposure in number of load cycles and f is the frequency of the fatigue load cycles (Hz),
bₜₕ is a minimum FWHM peak width (degrees) when

$$t = \frac{N}{f} \to ∞ ,$$

and

b_{sd} is a FWHM peak width (degrees) after shake down phase.

Optionally, another non-destructive method to inspect and get an observable and measurable parameter indicative of microstructural condition may be an ultrasonic inspection of the metal object. Other non-destructive techniques may also be used, such as radiographic based techniques, laser-based techniques, or any other non-destructive inspection method known by the skilled person.

Optionally, the method includes a depth dependent residual stress σₓₓ^{res} to reflect variations of in depth for more accurate indications of microstructural decay.

By shakedown phase is meant the first stage of RCF. The accumulation of the micro-plasticity is controlled by the subsurface stress state that develops under contact loading. The accumulation of plasticity can be divided into two main stages:
1) the shakedown stage (Stage 1) characterized by material hardening (N≤10⁵ cycles), and
2) the steady state (Stage 2), which is characterized by a very small damage rate per cycle (N≈10⁵-10¹⁰ cycles).

The length of the first stage is nearly negligible compared to the length of the second phase. The innovative method according to the disclosure provides an accurate prediction of damage accumulation during RCF stage 2, which in turn leads to better indication of microstructural deterioration and estimation on remaining life.

Thus, there is provided a method of indicating an evolution of a Fatigue Damage Index for the hardened metal object as a function of fatigue load cycles, N. The method comprises a step of obtaining a solution to the equation in any of the embodiments of the first aspect of the disclosure by integrating the equation over fatigue exposure in load cycles and then calculating the evolution of a Fatigue Damage Index by dividing the solution by an original value of the measurable parameter indicative of the microstructural condition of the hardened metal object prior to fatigue exposure.

Thus, there is provided a method of determining the expected life of a hardened metal object in relation to a number of load cycles (N_{LIFE}) exerted on the hardened metal object. The method comprises steps of: Measuring an actual value of Fatigue Damage Index for the hardened metal object, calculating the evolution of Fatigue Damage Index, calibrating the calculated evolution on the basis of the measured value of Fatigue Damage Index and determining the expected life (N_{LIFE}) on the basis of a known critical value of Fatigue Damage Index that leads to material failure, where the number of fatigue load cycles corresponding to the critical value of the Fatigue Damage Index (N_{CRITICAL} FDI) equals the expected life.

Optionally, the known critical value of Fatigue Damage Index is obtained from fatigue life tests performed on similar hardened metal objects made from the same hardened metal as the hardened metal object for which the expected life is determined, or wherein the known critical value of Fatigue Damage Index is obtained by L10 life tests.

Thus, there is provided a method of determining the remaining life of a hardened metal object in relation to fatigue load cycles (N_{RL}) exerted on the hardened metal object. The method comprising a first step of calculating the expected life of the hardened metal (N_{LIFE}), and a second step of subtracting an actual number of fatigue load cycles (N_{ACTUAL}) from the expected life of the hardened metal (N_{LIFE}).

The remaining life calculation may advantageously be used for quality control in production, e.g., by inspecting the metal component after it has been produced and calculating its remaining life according to the method as disclosed herein. Accordingly, as an example, the metal component may be selected as quality approved if the calculated remaining life is within a predetermined quality range. In addition, the method for calculating remaining life of a metal component may be done as part of a predictive maintenance operation, e.g., by performing subsurface inspection during use of the metal component. Accordingly, it may be decided to perform maintenance of the metal component if the calculated remaining life is within a predetermined maintenance range. Still further, by the method for calculating remaining life of a metal component, time for testing may be shortened. This implies reduced energy consumption and increased test rig availability.

Optionally, the method according to the fourth aspect is used for determining whether or not to remanufacture the hardened metal object.

A method to remanufacture a hardened metal component may comprise: performing the method according to the fourth aspect of the disclosure for a hardened metal component to calculate remaining life, and deciding if the calculated remaining life makes it worthwhile to remanufacture, and remanufacturing the hardened metal, such as remanufacturing a raceway surface of the selected bearing component, only if it is determined that the calculated remaining life makes it worthwhile to remanufacture.

Thereby, a remanufactured metal component will be provided for which the remaining life will be extended as a consequence of the remanufacturing.

Remanufacturing may for example comprise, in the case of a bearing, machining a raceway surface of the bearing component. For example, the machining operation may comprise at least one of grinding, honing, superfinishing and polishing.

Optionally the hardened metal object is a bearing component, such as an inner ring, an outer ring, or a rolling element, such as a roller.

For example, the bearing component may be for a bearing such as a ball bearing or roller bearing, including but not limited to a spherical roller bearing, a tapered roller bearing, a toroidal roller bearing, a cylindrical roller bearing, a spherical ball bearing, a deep groove ball bearing and an angular contact ball bearing. Alternatively, the bearing may be a plain bearing, such as a spherical plain bearing. The bearing may be a bearing for any type of industrial application, such as but not limited to pulp and paper applications, wind turbines, metal and mining industry applications, railway applications, automotive applications etc. Additionally, or alternatively, the bearing may be of different sizes, such as a large-size bearing and a mid-size bearing. A large-size bearing may be defined as a bearing with an outer diameter being greater than 500 mm and a mid-size bearing may be defined as a bearing with an outer diameter of 100-500 mm.

According to a fifth aspect of the disclosure, at least one object discussed above is at least partly achieved by a computer program product. The computer program product is loadable into the internal memory of a computer, comprising software code portions for performing any of the methods according to the previous aspects of the disclosure, when run on a computer. The computer program can also be stored on a non-transient computer readable medium.

According to a sixth aspect of the disclosure, at least one object is at least partly achieved by a computer readable medium. The computer readable medium, which may be a non-transient computer readable medium, contains program instructions for execution on a computer system, which when executed by the computer system, cause the computer system to perform the methods recited in any of the previous aspects of the disclosure.

A number of aspects/embodiments of the invention have been described. It is to be understood that each aspect/embodiment may be combined with any other aspect/embodiment, unless clearly indicated to the contrary.

### BRIEF DESCRIPTION OF THE DRAWINGS

The present disclosure will hereinafter be further explained by means of non-limiting examples with reference to the appended schematic figures in which:

FIG. 1 is an example of FWHM values obtained for an unused bearing and for a fatigue-loaded bearing according to an example embodiment of the present disclosure.

FIG. 2 is a graph of calculated microstructural deterioration over time as a function of fatigue load cycles according to an example embodiment of the present disclosure.

FIG. 3 is a graph of calibration curves for microstructural deterioration as a function of fatigue exposure time according to an example embodiment of the present disclosure.

FIG. 4 is a graph of Fatigue Damage Index as a function of fatigue load cycles according to an example embodiment of the present disclosure.

FIG. 5 is a flowchart of a method according to an embodiment of the present disclosure.

FIG. 6 is a schematic illustration of a device suitable for executing the methods according to an example embodiment of the present disclosure.

FIG. 7 is a schematic view of a rolling bearing according to an example embodiment of the present disclosure.

FIG. 8A is a graph showing predicted indications of evolution of microstructural deterioration vs tests using a method according to prior art.

FIG. 8B is a graph showing predicted indications of evolution of microstructural deterioration vs tests using a method according to an example embodiment of the present disclosure.

### DETAILED DESCRIPTION OF PREFERRED EMBODIMENTS

In order to clarify embodiments of the disclosure, some examples will now be described with reference to the attached figures. Furthermore, the disclosed methods will be described with particular reference to a rolling element bearing made of bearing steel that is subjected to rolling contact fatigue. It is to be understood, however, that the methods according the disclosure may be applied with regard to any type of hardened metal object 100 that is subjected to any type of cyclical fatigue loading.

A fundamental aspect of the disclosure is the understanding that during fatigue, the microstructure of materials experiences continuous changes until failure.

According to the present disclosure, fatigue damage is seen as a cumulative small-scale plastic deformation process, being controlled by a thermally activated dislocation climb process. The damage induced is a result of a secondary creep-like dislocation process, where iron self-diffusion-controlled climb constitutes the rate controlling step, while the major part of the damage induced is a result of dislocation glide, once the dislocations are freed from the obstacles via the climb process (climb and glide). The damage process is therefore driven by the applied shear stress field and is rate controlled via diffusion-controlled climb. The present disclosure is based on a metal physics description of the behavior of hardened (martensite or bainite) steels. Hardened steels can, from a metal physics point of view, be characterized as being non-equilibrium steels (at equilibrium all steels are soft). Hardened steels behave differently from softer steels under fatigue loading. Since fatigue is a result of accumulated damage, induced by incremental micro-plastic deformation in each load cycle, the key to improved predictability lies in understanding the micro-plastic behavior of hard steels.

While plastic deformation in softer steels is controlled by one deformation mechanism: dislocation glide or micro-yielding, plastic deformation in hard steels, in their non-equilibrium state, may be induced by two different mechanisms: dislocation glide and dislocation climb. The first deformation mechanism, dislocation glide, is only active above a given threshold stress level (the micro-yield limit), while dislocation climb, although strongly stress dependent, is active at all stress levels, not excluding the existence of a lower threshold stress level below which the climb mechanism does not occur. The dislocation climb mechanism is governed by diffusion processes. The fatigue response, therefore, also becomes strongly influenced by temperature, time and internal (hoop and residual) stresses and will therefore also be influenced by the frequency of the fatigue load cycles.

Fatigue exposed components made of hardened and low-temperature tempered steels typically fail due to crack initiation from various defects. With respect to rolling contact fatigue, these defects are present either at the raceway surface (indentations from handling damage or mounting, denting from contaminated running or surface damage induced from improper lubrication, etc.) or within the material, i.e. subsurface defects like non-metallic inclusions, pores, pre-existing cracks, etc. Defects like these act as local stress raisers leading to a locally accelerated fatigue damage. The shear stress driven and thermally activated fatigue damage processes discussed in this document occur at a higher rate in the steel matrix adjacent to the defects. The result is that the material, at some point in time, will fail locally at these highly stressed points, leading to crack initiation. From this point in time, the fatigue damage process will change to become one of crack propagation till failure (spalling).

The actual condition of a material surface or subsurface is therefore an important factor in the fatigue life of the material. Consequently, a further fundamental aspect of the disclosure is to quantify the material condition in terms of microstructural deterioration and combine this with the improved understanding of fatigue. The result is an improved method of determining the life and/or remaining life of e.g. a bearing, where the method is based on the measurement of changes in the microstructure of the bearing steel and relating this measurement to a known level of microstructural deterioration that leads to material failure.

According to the present disclosure, a method is provided for indicating the evolution of microstructural deterioration as a function of fatigue exposure time, based on the understanding that a direct relation exists between the plastic shear strain rate and the rate at which the microstructure deteriorates.

A preferred method of expressing microstructural deterioration is in terms of the line width of a specific diffraction peak on an X-ray diffractogram. The line width is generally expressed as Full Width at Half Maximum, which is abbreviated to FWHM. Among the factors which contribute to FWHM are material condition factors. It has been found that in hardened metals, the FWHM decreases as the number of microstructural defects increases as a result of accumulated plastic strain damage.

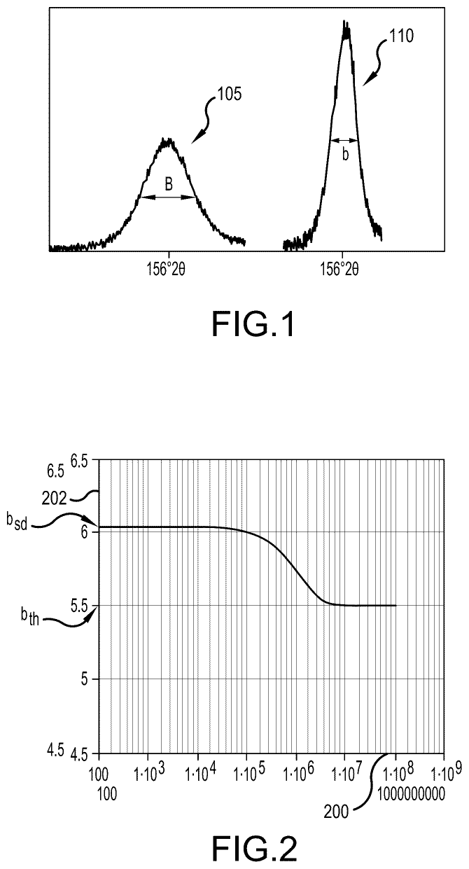

FIG. 1 depicts an example of the decrease in FWHM. Peaks 105, 110 are from X-ray diffraction measurements performed on a bearing prior to fatigue exposure 105 and after the bearing had been exposed to fatigue 110. Clearly, the FWHM value B of the unused bearing is greater than the FWHM value b of the fatigue-exposed bearing. The bearing used in the measurements was made from SAE 52100 bearing steel (DIN 100Cr6) and the X-ray diffraction measurement was performed using CrKα_{1,2} radiation and the 211-diffraction peak at approximately 156 degrees 2-theta.

It should be noted here that measurements of FWHM should be performed at the same depth. The measurement depth, z, depends on the mode of failure that is expected. If surface failure is expected, for example in starved lubrication conditions or in a large-size bearing where the rolling elements are subject to extensive slip, the FWHM measurement depth should be zero. If subsurface failure is expected, the depth at which maximum shear stress occurs may be used. Alternatively, a depth profile could be constructed, where consecutive measurements are performed after consecutive material removal steps. An integration value of FWHM over the full depth profile could then be used. Whatever measurement depth or depth profile is used, the most important consideration is that the same depth or depth profile is used consistently throughout the evaluation process. It should also be noted that when FWHM measurements are performed to determine material deterioration, they should be performed in a region of the mechanical object that has been exposed to maximum fatigue loading. In a rolling element bearing, this region might be the outer raceway surface in the loaded zone of the bearing, but the actual region depends on the application.

One embodiment of the present disclosure provides a method of indicating the evolution of microstructural deterioration 510 as a function of fatigue exposure time, where the microstructural deterioration is expressed in terms of FWHM. The method is based on a relationship between the rate of change in FWHM and the fatigue damage rate, where the rate of change in FWHM is representative of the rate of microstructural deterioration. The rate of change in another, suitable, measurable parameter indicative of microstructural condition could also be used. The fatigue damage rate is calculated on the basis of an effective activation energy parameter for the dislocation climb process, shear stress amplitude, absolute local temperature and fatigue exposure time. According to the disclosure, the relationship between the rate of microstructural deterioration and the fatigue damage rate may be expressed by means of the following differential equation:

$$b ( t ) = {b}_{th} + ( {b}_{sd} - {b}_{th} ) exp [ - {{γ}_{s} ( \frac{t}{{t}_{0}} )}^{d} ] \qquad ( equation 1 )$$

where
b(t) is a time dependent measurable parameter indicative of microstructural condition when time

$$t = \frac{N}{f} ,$$

where N is fatigue exposure in number of load cycles and f is the frequency of the fatigue load cycles (Hz),
bₜₕ is a minimum measurable parameter indicative of microstructural condition when

$$t = \frac{N}{f} \to ∞ ,$$

b_{sd} is a measurable parameter indicative of microstructural condition after shake down phase,
γₛ is plastic strain accumulation,
t₀ is a time normalization constant (seconds), and
d is a temperature dependent material exponential coefficient, where d<1.

The plastic strain accumulation Ys may be given by the equation

$${γ}_{s} = C {〈 \frac{{τ}_{xz}}{{τ}_{0}} 〉}^{c} exp ( - \frac{{Q}_{eff} - Δ V {σ}_{H}}{{k}_{b} T} ) \qquad ( equation 2 )$$

where
τ_{xz} is an orthogonal shear stress (Pa),
τ₀ is an activation stress for creep (Pa),
C is a proportionally constant for the shear stress amplitude,
c is an exponent for the shear stress amplitude,
Q_{eff} is an activation energy for creep (J),
k_{b} is a Boltzmann constant (J/K),
T is an operating temperature (K),
σ_{H} is the Hertzian hydrostatic pressure (Pa), and
ΔV (m³) is a material activation volume,

In an example embodiment, the material related parameters bₜₕ, τ₀, d, and/or ΔV are functions of temperature.

In an example embodiment, the measurable parameter indicative of the microstructural condition of the hardened metal object is a Full Width at Half Maximum, FWHM, obtainable from a diffraction peak of an X-ray diffraction measurement, where
b(t) is a time dependent FWHM peak width (degrees) when time

$$t = \frac{N}{f} ,$$

when N is fatigue exposure in number of load cycles and f is the frequency of the fatigue load cycles (Hz),
bₜₕ is a minimum FWHM peak width (degrees) when

$$t = \frac{N}{f} \to ∞ ,$$

and
b_{sd} is a FWHM peak width (degrees) after shake down phase.

FIG. 2 depicts a typical curve of the b(N) function, where the x-axis 200 represents fatigue exposure in load cycles and the y-axis 202 represents FWHM in degrees. Here, the curve represents fatigue exposure in load cycles a specific depth. The curve starts at the value after shakedown b_{sd}, decreases and then asymptomatically approaches its lowest threshold value bₜₕ. The evolution rate of b is proportional to fatigue damage rate, but has a threshold value below which no further change occurs.

Thus, equation 1 represents an expression for the evolution of microstructural deterioration of e.g. a bearing component 100 that is subjected to rolling contact fatigue, where the input parameters are measurable quantities (bₜₕ and b_{sd}), natural constants or material temperature dependent constants, and the operating conditions of the bearing 100.

With regard to a bearing subjected to rolling contact fatigue, the shear stress τ_{xz} may be calculated on the basis of the applied load and the geometry of the contact. The hydrostatic pressure, σ_{H}, may be calculated on the basis of the applied load and the geometry of the contact, the hoop stress and any residual stress. The temperature and speed can likewise be measured.

The proportionality constants are found by fitting the equations to experimental calibration test data.

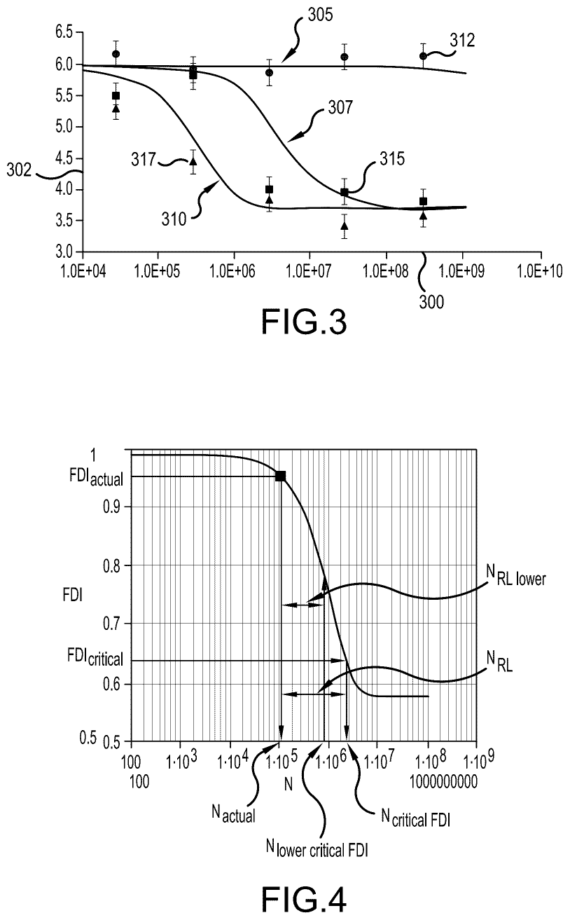

FIG. 3 depicts a graph of the data obtained from such a calibration test as mentioned above to find proportionality constants where the x-axis 300 represents number of fatigue load cycles and the y-axis 302 represents FWHM. The calibration test here is relevant for a bearing steel subjected to rolling contact fatigue. Three bearing sets from one bearing steel and heat treatment were operated under three different conditions. At predefined intervals, X-ray diffraction measurements were performed to obtain FWHM values corresponding to known numbers of load cycles. The three curves shown 305, 307 and 310 were obtained from the measured data points 312, 315 and 317, which data points are shown on the graph with their confidence levels. The three sets of data points 312, 315 and 317 correspond to three sets of operating condition at predetermined values of operating temperature, contact pressure and hoop stress.

According to a further aspect of the disclosure, a method of determining the evolution of a Fatigue Damage Index 520 as a function of fatigue exposure time, FDI(t), is provided. The method is based on the following equation:

$$FDI ( t ) = \frac{b ( t )}{B} \qquad ( equation 3 )$$

where
B(t) is obtained according to equation 1, and
B is the original B is the original FWHM value (degrees) of the hardened metal object, measured at the depth z.

The evolution of FDI may also be expressed in load cycles N, FDI(N).

The Fatigue Damage Index, FDI, is a measure of the condition of a material relative to its original condition. For any material, there is a critical value of the Index, FDI_{critical}, at which failure is imminent. With regard to rolling element bearings, life tests are performed on a population of bearings under predefined operating conditions. From these tests, an L10 life is derived, which is the time or number of load cycles after which 10 percent of the tested population has failed. Bearing failure is deemed to have occurred when the measured vibration exceeds a predefined limit. From such L10 life tests, and from X-ray diffraction measurements of the failed bearings, it has been found that in surface failure mode, FDI_{critical}, for bearing steel is approximately equal to 0.86. One example of a value for FDI_{critical} in subsurface failure mode is 0.64. The value of FDI_{critical} also depends on the material and heat treatment, the type of bearing, and, to some extent, on the operating conditions. However, an average value of FDI_{critical} for a particular material and heat treatment is a useful approximation.

According to an embodiment of the present disclosure, the value of FDI_{critical} may be used to determine the expected life of a bearing or other hardened metal object 100 that is exposed to fatigue.

FIG. 4 shows an example of a graph of FDI(N) for a certain bearing operated under a given set of operating conditions. The x-axis represents fatigue exposure time in number of load cycles and the y-axis represents the Fatigue Damage Index. The curve is fitted through one or more experimentally determined data points. Preferably, these data points are known data points for the bearing in question, operated under the given set of operating conditions. Using the example for subsurface failure, where FDI_{critical}=0.64 (obtained from L10 life tests), it can be seen from FIG. 4 that the projected L10 life of the bearing, NL10, may be obtained from the number of load cycles that corresponds to FDI_{critical}. In other words, NL10=N_{criticalFDI}

Thus, according to the disclosure, a method of determining the expected fatigue life of a hardened metal object is provided. In the above example, an L10 life was calculated, as this is the standard way of expressing bearing life. It will be clear, however, that the method may be adapted to determine life according to a different standard.

It is also standard practice in the field of bearing life tests to quote an upper and a lower confidence limit. These limits are obtained from L10 life test data, for example, by means of a statistical interpretation of a set of possible combinations. Thus, an L10 life test results in a certain bearing life (number of fatigue load cycles), N_{lifetest}, which has a certain upper confidence limit, Nᵤₚₚₑᵣ, and a certain lower confidence limit, N_{lower}. The same principle may be applied to the method of the disclosure in order to obtain a lower confidence limit for the number of fatigue load cycles corresponding to the critical Fatigue Damage Index, N_{lowercriticalFDI}, and an upper confidence limit for the number of fatigue load cycles corresponding to the critical Fatigue Damage Index, N_{uppercriticalFDI}. The lower confidence limit is obtained according to

$${N}_{lowercriticalFDI} , = ( {N}_{lower} / {N}_{lifetest} ) \times {N}_{criticalFDI} \qquad ( equation 4 )$$

The upper confidence limit is obtained according to

$${N}_{lowercriticalFDI} , = ( {N}_{lower} / {N}_{lifetest} ) \times {N}_{criticalFDI} \qquad ( equation 5 )$$

According to a further aspect of the present disclosure, a method of calculating the remaining life of a hardened metal object 100 is provided.

As described previously, the fatigue life of a hardened metal object 100 may be obtained from equation 1 in combination with a known critical value of material deterioration that leads to failure, where fatigue life=N_{criticalFDI}. Remaining life, expressed as a number of fatigue load cycles, N_{RL}, can therefore be calculated by subtracting an actual number of fatigue load cycles, N_{actual}, i.e.

$${N}_{RL} = {N}_{criticalFDI} - {N}_{actual} \qquad ( equation 6 )$$

The actual number of fatigue load cycles that an object has experienced may also be obtained from equation 1, by determining an actual Fatigue Damage Index, FDI_{actual}. As described previously, this value may be obtained by measuring the FWHM in a region that has undergone maximal fatigue loading and dividing the result of the measurement by the original FWHM value. The original FWHM value may be a known value for the hardened metal and heat treatment concerned, or it may be obtained by measuring the FWHM in a region of the object that was not subjected to fatigue loading. Again, with reference to FIG. 4, it may be seen that the actual number of fatigue load cycles N_{actual} is the number that corresponds to FDI_{actual}. If the actual number of fatigue load cycles is known, this value together with the measured value for FDI_{actual} is used as a known data point through which the equation for FDI(N) is fitted.

The remaining life N_{RL} is then calculated according to equation 6.

The remaining life N_{RL} may also be expressed in terms of a lower and an upper confidence limit, N_{RL lower} and N_{RL upper}, by utilizing the lower and upper confidence limits calculated in equations X and X respectively. Thus,

$${N}_{RL lower} = {N}_{lower criticalFDI} - {N}_{actual} and \qquad ( equation 7 )$$

$${N}_{RL upper} = {N}_{lower criticalFDI} - {N}_{actual} \qquad ( equation 8 )$$

The result of a remaining life calculation according to equation 7, N_{RL lower}, is also shown in the graph of FIG. 4.

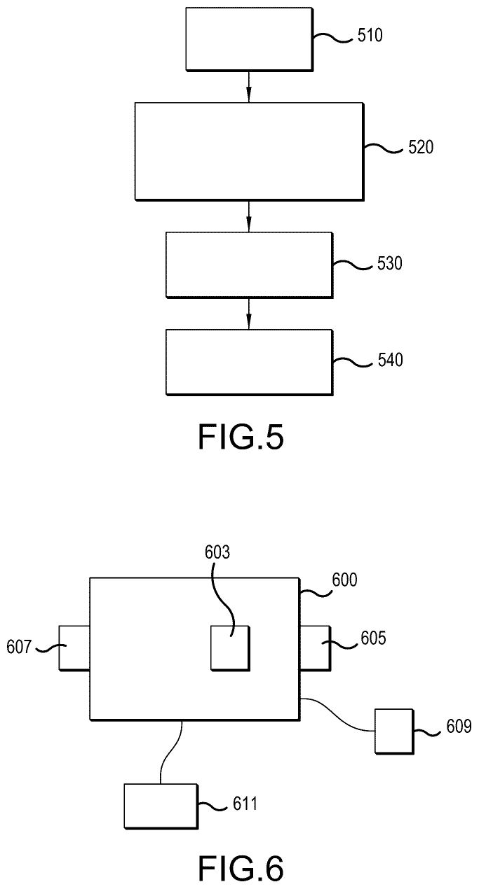

FIG. 5 is a flowchart of a method according to the disclosure. In the case of a hardened metal object that has been exposed to a number of fatigue loads cycles, N_{actual}, preferred method according to disclosure of determining the expected life, N_{LIFE}, and remaining life, N_{RL}, in relation to fatigue load cycles, is shown schematically in the flowchart of FIG. 5.

In a first step 510, the actual Failure Damage Index, FDI_{actual}, of the metal object is established by measuring a parameter indicative of the actual microstructural condition of the metal object and dividing this measured parameter by an original parameter value, where the original parameter value is indicative of the microstructural condition of the metal object prior to fatigue exposure.

In a second step 520, the evolution of FDI as a function of fatigue load cycles is calculated, where the input parameters for the corresponding equation are the fatigue loading conditions and material properties of the hardened metal object and where the equation is fitted through the value of FDI_{actual} obtained in the first step.

In a third step 530, the expected life of the hardened metal object in relation to a number of fatigue load cycles, N_{LIFE} is determined by means of a known critical value of FDI that leads to material failure, FDI_{critical}, where N_{LIFE} is obtained from the number of fatigue load cycles that corresponds to FDI_{critical}.

In a fourth step 540, the remaining life of the hardened metal object is determined by subtracting the actual number of fatigue load cycles exerted on the hardened metal object, N_{actual}, from N_{LIFE}.

FIG. 6 depicts a device 600 suitable for executing the methods according to the present disclosure is given. It comprises a processor 603 for executing the methods, and input/output means 605, such as a mouse or a keyboard. In one embodiment, it comprises data communication capabilities 607 for receiving and transmitting metal object data and possibly results. It may also comprise a screen 609 and/or another output device such as a printer 611 for outputting results from the execution of the methods according to the present disclosure.

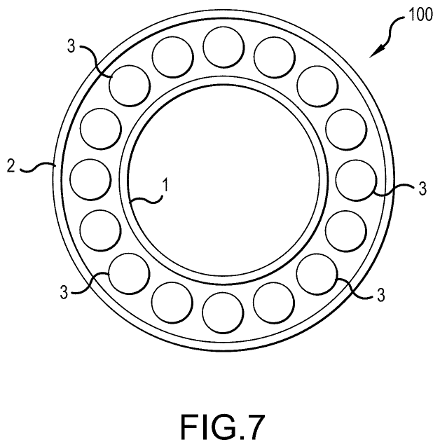

FIG. 7 depicts a schematic view of hardened metal objects 100 according to an example embodiment of the present disclosure. Here, the metal components are bearing components such as an inner ring 1, and outer ring 2 and rolling elements 3 are shown.

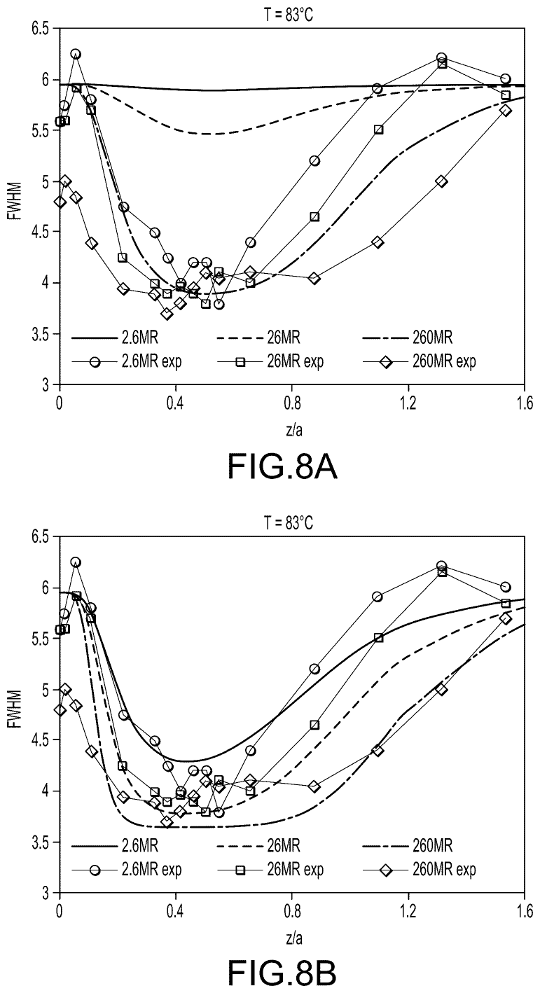

FIG. 8A and FIG. 8B show graphs over predicted indications of evolution of microstructural deterioration vs tests. A method according to prior art is used in FIG. 8A, and a method according to an example embodiment of the present disclosure is used in FIG. 8B.

Here, FWHM along depth z coordinate normalized by a predictions can be seen for different number of cycles N₁=2.6e6, N₂=26e6 and N₃=260e6 at running temperatures of T=83ºC.

The lines with symbols are experimental results while solid and dotted lines are the model predictions. The related predictions and experimental results can be seen stacked on each other in the bottom of the graph.

It shows FWHM predicted using two models and compared against experimental results obtained in bearing fatigue tests. The predictions of the new model according to the disclosure are in excellent agreement with experiments across wide range of number of stress cycles and as a function of the depth from the raceway. This, however, is not the case with the old model.

It should be noted that the drawings have not necessarily been drawn to scale and that the dimensions of certain features may have been exaggerated for the sake of clarity.

A programmable hardware component can be formed by a processor, a computer processor (CPU=central processing unit), an application-specific integrated circuit (ASIC), an integrated circuit (IC), a computer, a system-on-a-chip (SOC), a programmable logic element, or a field programmable gate array (FGPA) including a microprocessor.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved methods for determining microstructural deterioration and remaining life of a hardened metal component.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

What is claimed is:

1. A method of indicating an evolution of a microstructural deterioration of a hardened metal object in relation to fatigue load cycles, N, exerted on the hardened metal object, the method comprising:
determining the evolution of microstructural deterioration using a relationship between a rate of change in a measurable parameter indicative of the microstructural condition of the hardened metal object and a fatigue damage rate of the hardened metal object, wherein the method is given by the equation:
$$b = {b}_{th} + ( {b}_{sd} - {b}_{th} ) exp [ - {{γ}_{s} ( \frac{t}{{t}_{0}} )}^{d} ]$$
where
b(t) is a time dependent measurable parameter indicative of microstructural condition when time
$$t = \frac{N}{f} ,$$
where N is fatigue exposure in number of load cycles and f is the frequency of the fatigue load cycles (Hz),
bₜₕ is a minimum measurable parameter indicative of microstructural condition when
$$t = \frac{N}{f} \to ∞$$
b_{sd} is a measurable parameter indicative of microstructural condition after shake down phase,
γₛ is plastic strain accumulation,
t₀ is a time normalization constant (seconds), and
d is a temperature dependent material exponential coefficient, where d<1.

2. The method according to claim 1, wherein the plastic strain accumulation Ys is given by the equation
$${γ}_{s} = C {〈 \frac{{τ}_{x z}}{{τ}_{0}} 〉}^{c} exp ( - \frac{{Q}_{eff} - Δ V {σ}_{H}}{{k}_{b} T} )$$
where
τ_{xz} is an orthogonal shear stress (Pa),
τ₀ is an activation stress for creep (Pa),
C is a proportionally constant for the shear stress amplitude,
c is an exponent for the shear stress amplitude,
Q_{eff} is an activation energy for creep (J),
k_{b} is a Boltzmann constant (J/K),
T is an operating temperature (K),
σ_{H} is the Hertzian hydrostatic pressure (Pa), and
ΔV (m³) is a material activation volume,
wherein at least one of the material related parameters bₜₕ, τ₀, d, and/or ΔV are functions of temperature.

3. The method according to claim 1, wherein the measurable parameter indicative of the microstructural condition of the hardened metal object is a Full Width at Half Maximum, FWHM, obtained from a diffraction peak of an X-ray diffraction measurement, where:
b(t) is a time dependent FWHM peak width (degrees) when time
$$t = \frac{N}{f} ,$$
where N is fatigue exposure in number of load cycles and f is the frequency of the fatigue load cycles (Hz),
bₜₕ is a minimum FWHM peak width (degrees) when
$$t = \frac{N}{f} \to ∞ ,$$
and
b_{sd} is a FWHM peak width (degrees) after shake down phase.

4. A method of indicating an evolution of a Fatigue Damage Index for the hardened metal object as a function of fatigue load cycles, N, wherein the method comprises:
obtaining a solution to the equation in the method in claim 1 by integrating the equation over fatigue exposure in load cycles and then calculating the evolution of a Fatigue Damage Index by dividing the solution by an original value of the measurable parameter indicative of the microstructural condition of the hardened metal object prior to fatigue exposure.

5. A method of determining the expected life of a hardened metal object in relation to a number of load cycles (N_{LIFE}) exerted on the hardened metal object, wherein the method comprises:
measuring an actual value of Fatigue Damage Index for the hardened metal object;
calculating the evolution of Fatigue Damage Index according to the method of claim 4;
calibrating the calculated evolution on the basis of the measured value of Fatigue Damage Index; and
determining the expected life (N_{LIFE}) on the basis of a known critical value of Fatigue Damage Index that leads to material failure,
where the number of fatigue load cycles corresponding to the critical value of the Fatigue Damage Index (N_{CRITICAL} FDI) equals the expected life.

6. A method of determining the remaining life of a hardened metal object in relation to fatigue load cycles (N_{RL}) exerted on the hardened metal object, the method comprising:
calculating the expected life (N_{LIFE}) of the hardened metal object according to the method in claim 5, and
subtracting an actual number of fatigue load cycles (N_{ACTUAL}) from the expected life of the hardened metal (N_{LIFE}).

7. The method of determining the remaining life according to claim 6, wherein the method is used to determine whether or not to remanufacture the hardened metal object.

8. The method according to claim 1,
wherein the hardened metal object is a bearing inner ring, a bearing outer ring, or a bearing rolling element.

9. A computer program product loadable into the internal memory of a computer, comprising software code portions for performing the methods of claim 1 when run on a computer.

10. A non-transient computer readable medium containing program instructions for execution on a computer system, which when executed by the computer system, cause the computer system to perform the methods recited in claim 1.
